(19) United States
(12) Patent Application Publication
(10) Pub. No.: US 2007/0229408 A1
(43) Pub. Date: Oct. 4, 2007

(54) Active matrix display device

(75) Inventor: Bruno Primerano, Honeoye Falls, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/395,711

(22) Filed: Mar. 31, 2006

(51) Int. Cl. G09G 3/30

(52) U.S. Cl. 345/76

(57) ABSTRACT

A display device includes address decoding circuitry for causing the activation or deactivation of the pixel circuits a row at a time during a cycle containing a plurality of different time windows, wherein each time window has different time values, the total time of activated windows for a given pixel circuit corresponds to the desired brightness of the display element of such circuit, such address decoding circuitry including: i) column select circuitry for providing the activating and deactivating data signals on the data lines; ii) a random access decoder responsive to address signals for providing the select signals on the select lines of a desired row in the matrix; and iii) control circuitry for producing the addresses for the random access decoder and for providing data signals to the column select circuitry so that each pixel is activated for a time corresponding to its desired brightness.

### FIELD OF THE INVENTION

The present invention relates to an active matrix-type display device for driving display elements.

### BACKGROUND OF THE INVENTION

In recent years, it has become necessary for mobile information terminals to also have processing performance, matching that of personal computers. It is also expected by consumers, that image display devices, have high-resolution and high picture quality, and it is desirable for such image display devices to have low power consumption and be thin, lightweight, and visible from wide angles. With such requirements, display devices (displays) have been developed where thin-film active elements (thin-film transistors, also referred to as TFTs) are formed on a glass substrate, with display elements then being formed on top.

In general, a substrate forming active elements is such that patterning and interconnects formed using metal are provided after forming a semiconductor film of amorphous silicon or polysilicon. Due to differences in the electrical characteristics of the active elements, the former requires ICs (Integrated Circuits) for drive use, and the latter is capable of forming circuits for drive use on the substrate. In liquid crystal displays (Liquid Crystal Displays or simply LCDs) currently widely used, the amorphous crystal type is widespread for large-type screens, because the polysilicon type is more common in medium and small screens.

Of mass-produced self-luminous type screens, polysilicon type displays are the only electroluminescent (organic EL) displays characterized by being thin, lightweight and having a wide angle of visibility. Typically, organic EL elements are used in combination with TFTs and utilize a voltage/current control operation so that current is controlled. The current/voltage control operation refers to the operation of applying a voltage to a TFT gate terminal so as to control current between the source and drain. As a result, it is possible to adjust the intensity of light emitted from the organic EL element and to control the display to the desired gradation.

However, in this configuration, the intensity of light emitted by the organic EL element is extremely sensitive to the TFT characteristics. In particular, for polysilicon TFTs formed using low-temperature processes (referred to as low-temperature polysilicon), it is known that comparatively large differences in electrical characteristics occur between neighboring pixels. This is a major cause of deterioration of the display quality of organic EL displays, in particular, screen uniformity.

Related art for improving this is taught by Ouchi et al. in U.S. Pat. Nos. 6,724,377 and 6,885,385. The polysilicon TFTs driving the organic EL element are driven so as to be in one of two states, either lit-up, or extinguished (digital driving). This suppresses variations in the characteristics, and this enables gradation as a result of controlling this illumination period. In order to control the illumination period of the organic EL, a plurality of drive circuits (e.g. shift registers) capable of a plurality of scans are added, instead of the single shift register common in analog devices. The number of TFT circuits is therefore increased, and the circuit failure rate therefore increases accordingly. In particular, a high-definition display panel will have a very large number of pixels and drive circuits, which will cause yield to fall and costs to increase, and require that a larger portion of the device be given over to non-displaying control apparatus.

It is therefore advantageous for the present invention to implement a high-quality organic EL display for which the number of circuits for digital driving is kept small and display uniformity is high.

### SUMMARY OF THE INVENTION

It is therefore an object of the present invention to provide a high-quality organic EL display, for which the number of circuits for digital driving is kept small and display uniformity is high.

This object is achieved by a display device comprising:
a) a plurality of pixel circuits arranged in a matrix of rows and columns, wherein each pixel circuit includes a display element and a plurality of thin-film transistors, including a select transistor and a power transistor, for controlling the current flow through the display element, and each display element causes display light to be produced;
b) data lines corresponding to the columns of pixel circuits of the display array for providing activating or deactivating data signals to the pixel circuits;
c) a plurality of select lines corresponding to the rows of pixel circuits of the display matrix for providing select signals to designated select transistors in the rows of the matrix such that when an activating or deactivating data signal is simultaneously applied to the power transistor through the select transistor with a select signal to a pixel circuit the power transistor of such circuit is respectively activated or deactivated and produces a predetermined current flow through the corresponding display element, such power transistors remaining activated or deactivated at least until the row receives a subsequent select signal; and
d) address decoding structure for causing the activation or deactivation of the pixel circuits a row at a time during a cycle containing a plurality of different time windows, wherein each time window has different time values, the total time of activated windows for a given pixel circuit corresponds to the desired brightness of the display element of such circuit, such address decoding structure including:
   i) column select circuitry for providing the activating and deactivating data signals on the data lines;
   ii) a random access decoder responsive to address signals for providing the select signals on the select lines of a desired row in the matrix; and
   iii) control circuitry for producing the addresses for the random access decoder and for providing data signals to the column select circuitry so that each pixel is activated for a time corresponding to its desired brightness.

It is an advantage of this invention that a display is digitally driven without the need for multiple shift registers as in the prior art. It is a further advantage that this apparatus permits the use of multiple embodiments of time windows in a single digitally driven display device, therefore providing greater flexibility in the display device.

### BRIEF DESCRIPTION OF THE DRAWINGS

FIG. 1 is a schematic view of an overall configuration for one embodiment of a display device according to the present invention;

FIG. 2 is a schematic view showing a pixel circuit that is used in the present invention;

FIG. 3 is a schematic view of a configuration of column select circuitry that is used in the present invention;

FIG. 4 is a schematic view for an embodiment of a random access decoding circuit that is used in the present invention;

FIG. 5 is a schematic view of a random access decoder that is used in the present invention;

FIG. 6A is a graphical view showing an embodiment of a four-bit digital drive scanning sequence that is used in this invention;

FIG. 6B is a graphical view showing another embodiment of a four-bit digital drive scanning sequence that is used in this invention;

FIG. 7 shows an expanded view of the timing signals of a portion of FIG. 6A;

FIG. 8 shows an expanded view of a portion of FIG. 7 with additional signals; and

FIG. 9 shows a schematic view of another embodiment of a display device according to the present invention.

### DETAILED DESCRIPTION OF THE INVENTION

The term “pixel” is employed in its art-recognized usage to designate an area of a display panel that is stimulated to emit light independently of other areas. It is recognized that in full-color systems, several pixels of different colors will be used together to produce a wide range of colors, and a viewer can term such a group a single pixel. For the purposes of this discussion, such a group will be considered several different colored pixels.

Turning now to FIG. 1, there is shown a schematic view of an overall configuration for one embodiment of a display device according to the present invention. Display device 10 includes a plurality of pixel circuits arranged in a matrix of rows and columns in display matrix 20. Display device 10 further includes data lines, e.g. data line 80, which correspond to the columns of pixel circuits in display matrix 20. The data lines provide activating or deactivating data signals to the pixel circuits. Display device 10 further includes a plurality of select lines, e.g. select line 90, corresponding to the rows of display matrix 20. The select lines provide select signals to designated select transistors in the rows of display matrix 20. Display device 10 further includes address decoding circuitry 25 for causing the activation or deactivation of the pixel circuits a row at a time. Address decoding circuitry 25 includes column select circuitry 30, random access decoding circuit 40, and control circuitry 60. These elements and their operation will be explained further.

Memory buffer 50 is a frame memory for use in implementing digital driving for exchanging data with control circuitry 60 via a memory bus 55. Basically, one cycle or frame portion of data is stored at memory buffer 50. Input signal bus 70 is for transmitting image data and synchronization signals from outside. Data signal bus 65 supplies data and control signals from control circuitry 60 to column select circuitry 30. Address bus 75 supplies address signals from control circuitry 60 to random access decoding circuit 40.

Control circuitry 60 and memory buffer 50 can also be made of individual ICs but this requires a certain degree of bus width for the memory bus 55, increases the number of pins for control circuitry 60, increases the mounting surface area and also causes costs and power consumption to rise. It is therefore also possible to build the frame memory into the control circuit as a SoC (System On Chip) and use this as a single IC. Alternatively, control circuitry 60 and memory buffer 50 can also be encapsulated in a single package to give an SiP (System In Package) with memory bus 55 then being housed within the package so as to reduce the mounting surface area, and thereby reduce the number of external pins and the power consumption.

Currently, ICs are provided where RAM referred to as RAM-built-in drivers is incorporated within the data driver at an IC for liquid crystal display use. It is desirable to include memory buffer 50 within column select circuitry 30 in this case.

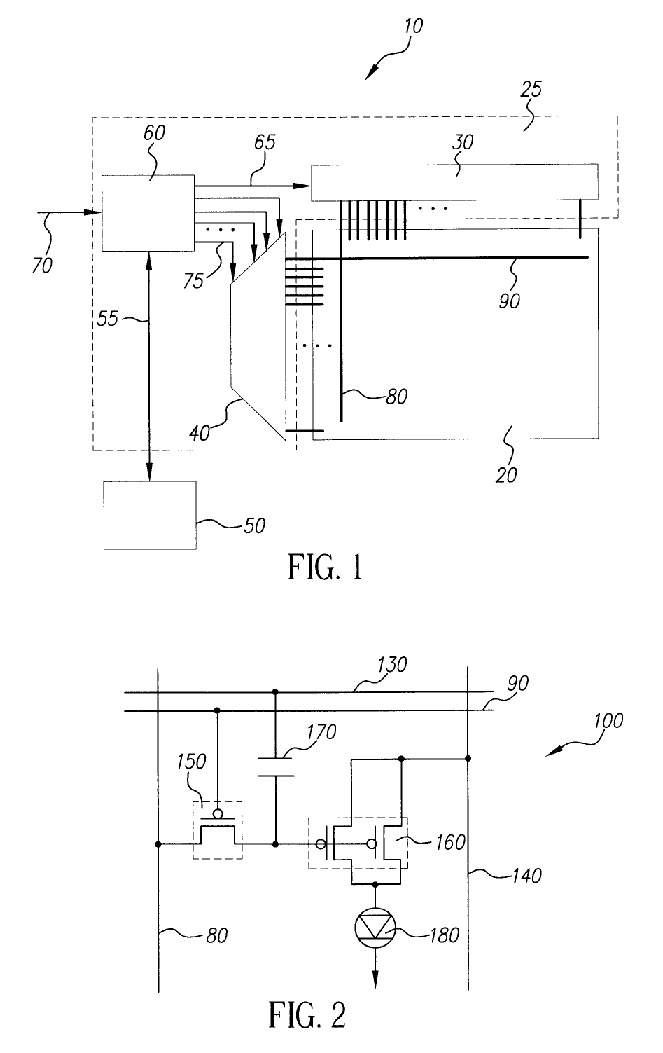

Turning now to FIG. 2, there is shown a schematic view of one embodiment of a pixel circuit that is used in the present invention. Pixel circuit 100 includes display element 180. In this embodiment, display element 180 is a diode, and in particular is an organic light-emitting diode (OLED). Display element 180 therefore represents the emitting portion of one pixel of display device 10. The pixel is a monochrome pixel. More commonly, display device 10 is a full-color display wherein the pixel circuits include at least three different colored pixels, e.g. red-light-emitting pixels, green-light-emitting pixels, and blue-light-emitting pixels, and can include other pixels as well, e.g. white-light-emitting pixels. Display element 180 can employ a full color method such as a method using red-light-emitting material in red pixels, green-light-emitting material in green pixels, and blue-light-emitting material in blue pixels, or alternatively a method dispersing wideband emitted light using red, green, and blue color filters. It is a bottom emitter type where light emission is derived from the anode side, or a top emitter type where light emission is derived from the cathode side, but the present invention is by no way limited in this respect.

Pixel circuit 100 further includes a plurality of thin-film transistors, including a select transistor 150 and a power transistor 160, and a hold capacitor 170. Power transistor 160 controls current flow through display element 180. Two TFTs are arranged in parallel in power transistor 160 to give a redundant construction where, in the event that electrical characteristics change at the electrodes of one transistor, it is still possible for the other TFT to operate to a certain extent. It is also possible to use more than two TFTs. However, if cases where increases in leakage current due to imperfect construction are common, it is preferable to use only one TFT. In a bottom-emitting display, where the object is to make the aperture ratio large, it is preferable to use fewer TFTs.

A source terminal electrode of power transistor 160 is connected to a power supply line 140, and a drain terminal electrode of power transistor 160 is connected to the anode of display element 180. The gate terminal electrode of power transistor 160 is connected to one terminal electrode of a hold capacitor 170, and another terminal electrode of hold capacitor 170 is connected to a reference potential line 130. As a result, on/off switch operation of power transistor 160 is selected by writing either an activating or a deactivating voltage to hold capacitor 170. By activating voltage, we mean a voltage on the gate relative to the source sufficient to allow power transistor 160 to operate in the linear regime. In the embodiment shown here, the activating voltage will be a negative voltage. However, those skilled in the art will understand that other embodiments can include variations, e.g. the use of n-channel transistors that can require a positive voltage. By deactivating voltage, we mean a gate voltage relative to the source less than the threshold voltage of power transistor 160, e.g. zero volts. When hold capacitor 170—and therefore the gate of power transistor 160—has an activating voltage, a predetermined current will flow through power transistor 160, producing a predetermined current flow through corresponding display element 180, wherein display element 180 will cause display light to be produced. The term “activated” will be used herein to designate such pixel circuits, power transistors, and display elements. When hold capacitor 170 has a deactivating voltage, essentially no current will flow through power transistor 160 and corresponding display element 180. The term “deactivated” will be used herein to designate such pixel circuits, power transistors, and display elements. Select transistor 150 is a gate TFT for data writing, having a gate terminal connected to select line 90, a drain terminal connected to data line 80, and a source terminal connected to hold capacitor 170 and the gate terminal of power transistor 160. Power supply line 140, cathode terminal of the display element 180, and reference potential line 130 are shared by all of the pixel circuits. Select line 90 is shared by all of the pixel circuits in a given row, and data line 80 is shared by all of the pixel circuits in a given column. The TFTs shown in this embodiment are all p-channel TFTs, but can also be partially or entirely n-channel TFTs. Other embodiments are possible wherein display element 180 is connected between power supply line 140 and power transistor 160.

It will be understood by those skilled in the art that many variations of the pixel circuit are possible in this invention. For example, one can use either p-channel or n-channel transistors, or the order of power transistor 160 and display element 180 is reversed.

Display matrix 20, with its pixel circuits 100, data lines 80, select lines 90, reference potential lines 130, and power supply lines 140 are commonly formed on a display substrate. Such display substrates are well known in the art. The display substrate is an organic solid, an inorganic solid, or includes organic and inorganic solids. It is rigid or flexible and is processed as separate individual pieces, such as sheets or wafers, or as a continuous roll. Typical substrate materials include glass, plastic, metal, ceramic, semiconductor, metal oxide, metal nitride, metal sulfide, semiconductor oxide, semiconductor nitride, semiconductor sulfide, carbon, or combinations thereof, or any other materials commonly used in the formation of active-matrix OLED devices, e.g. low-temperature polysilicon or amorphous-silicon TFT substrate. The display substrate is a homogeneous mixture of materials, a composite of materials, or multiple layers of materials.

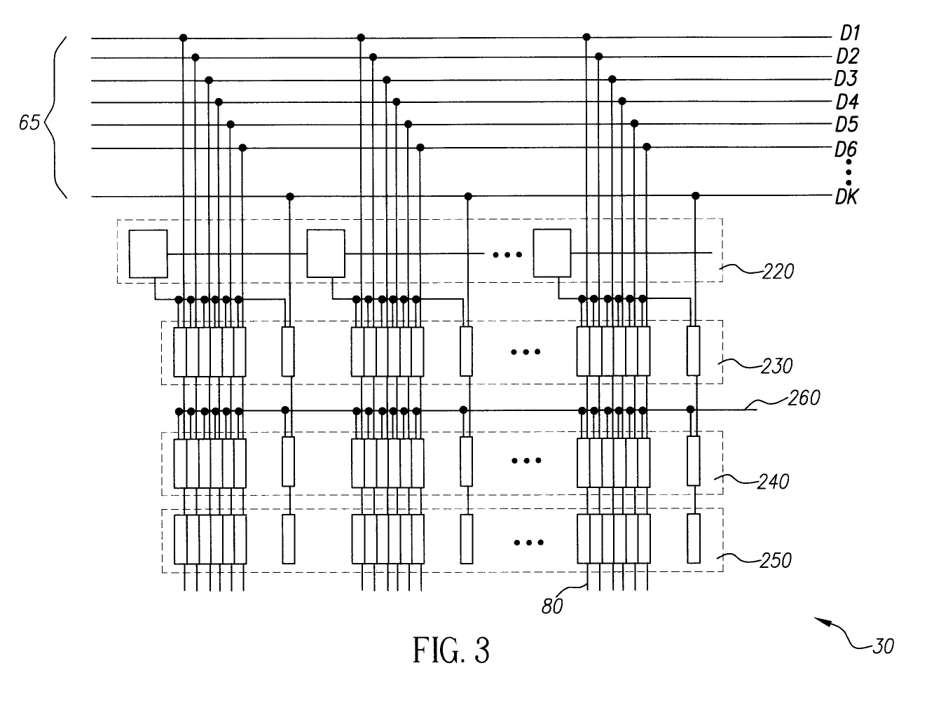

Turning now to FIG. 3, there is shown a schematic view of a configuration of column select circuitry that is used in the present invention. Column select circuitry 30 is part of address decoding circuitry 25 for causing the activation or deactivation of the pixel circuits a row at a time. Column select circuitry 30 is formed on the display substrate, or is a separate circuit so as to reduce the area of the display substrate used by non-display circuitry. Column select circuitry 30 provides activating and deactivating data signals on the data lines. Column select circuitry 30 is connected to data signal bus 65 and includes shift register 220, first data latch 230 for latching one bit of data on data signal bus 65, second data latch 240 for collectively latching one line of data for first data latch 230, and buffer 250 for driving data line 80 using the data of second data latch 240. Control signal line 260 collectively controls the transmitting of data from first data latch 230 to second data latch 240. Data line 80 provides activating or deactivating data signals, that is, an activating or deactivating voltage, respectively, to hold capacitor 170 of pixel circuit 100.

When digital driving, data for one pixel is transmitted to column select circuitry 30 using a single data line of data signal bus 65 because each data line 80 is only driven at two voltage levels, e.g. activating and deactivating, as described above. For example, if lines D1, D2, . . . , Dk of data signal bus 65 represent twenty-four one-bit data bus lines, it is possible to transmit a twenty-four-pixel portion at one time, or eight groups of RGB pixels, or six groups of RGBW pixels.

Data on data signal bus 65 is sequentially transferred to first data latch 230 using a sequentially shifting clock of shift register 220 with data for one line portion being held. Namely, data on data signal bus 65 is latched to a location corresponding to first data latch 230 by sequentially transferring the select signal in shift register 220. During this time, data of first data latch 230 is not reflected at second data latch 240. When the data of first data latch 230 is completely written for the row, it is loaded to second data latch 240 by setting control signal line 260 to active. Buffer 250 then drives data lines 80 with data for a one-line portion of the display matrix because that data is loaded to the pixel circuits as described above. During this time, first data latch 230 is sequentially filled with data for the next line, and that data subsequently transferred to second data latch 240. These operations are then repeated for the rows for the entire display in the manner described herein so that a display operation for one screen is complete.

In an analog drive display, the rows are scanned sequentially in a frame period or cycle. This scanning is commonly controlled by a shift register that activates the rows of pixel circuits in a single sequence for data writing. In a digital drive display, as taught by Ouchi et al. in U.S. Pat. Nos. 6,724,377 and 6,885,385, each cycle should contain a plurality of smaller time windows. This time window configuration is controlled by a plurality of shift registers that activate the rows of pixel circuits in a plurality of interleaved sequences for data writing. As mentioned above, a disadvantage of this configuration is that the need for multiple shift registers increases the required number of transistors on a display, and thus the portion of the display area that should be devoted to such controlling transistors.

Kawabe, in PCT Patent Publication WO2005/116971, taught an improvement to the above method wherein a single shift register is used to track the multiple sequences for data writing, and a series of enable control lines are used to control which of the multiple sequences is written at a given time. Because this removes the need for multiple shift registers, the number of enable control lines that have been designed into the system limits it. It can further require deviations from a strict binary combination of time windows.

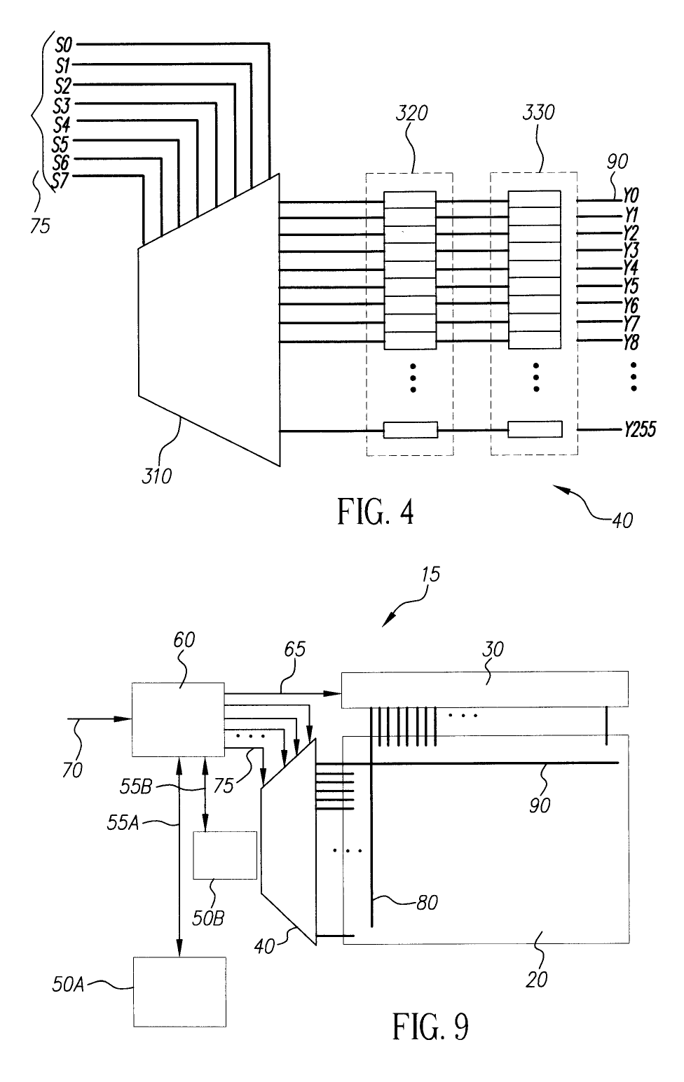

Turning now to FIG. 4, there is shown a schematic view for an embodiment of a random access decoding circuit that is used in the present invention. Random access decoding circuit 40 is part of address decoding circuitry 25 for causing the activation of the pixel circuits a row at a time. Random access decoding circuit 40 is formed on the display substrate, or is a separate circuit so as to reduce the area of the display substrate used by non-display circuitry. Random access decoding circuit 40 includes random access decoder 310, level shifter 320, and buffer 330. Random access decoder 310 is a known element responsive to address signals on address lines, represented by address bus 75, for providing select signals on select lines 90 of a desired row in the matrix. N address lines can select up to 2^{N} select lines, and thus random access decoder 310 can also be called an N-to-2^{N} decoder. In the embodiment of FIG. 4, random access decoder 310 shows an 8-to-256 decoder.

A select line 90 is selected by inputting address signals specifying an address on address bus 75 into random access decoder 310, which outputs a signal to level shifter 320 of the desired row. Level shifter 320 converts the signal level of random access decoder 310 to a signal level appropriate for driving a select line 90. Buffer 330 buffers the signal level of level shifter 320 so as to put the select line active by outputting this signal level to the appropriate select line 90, so as to control writing of data provided by column select circuitry 30 to a desired row of pixel circuits in the matrix.

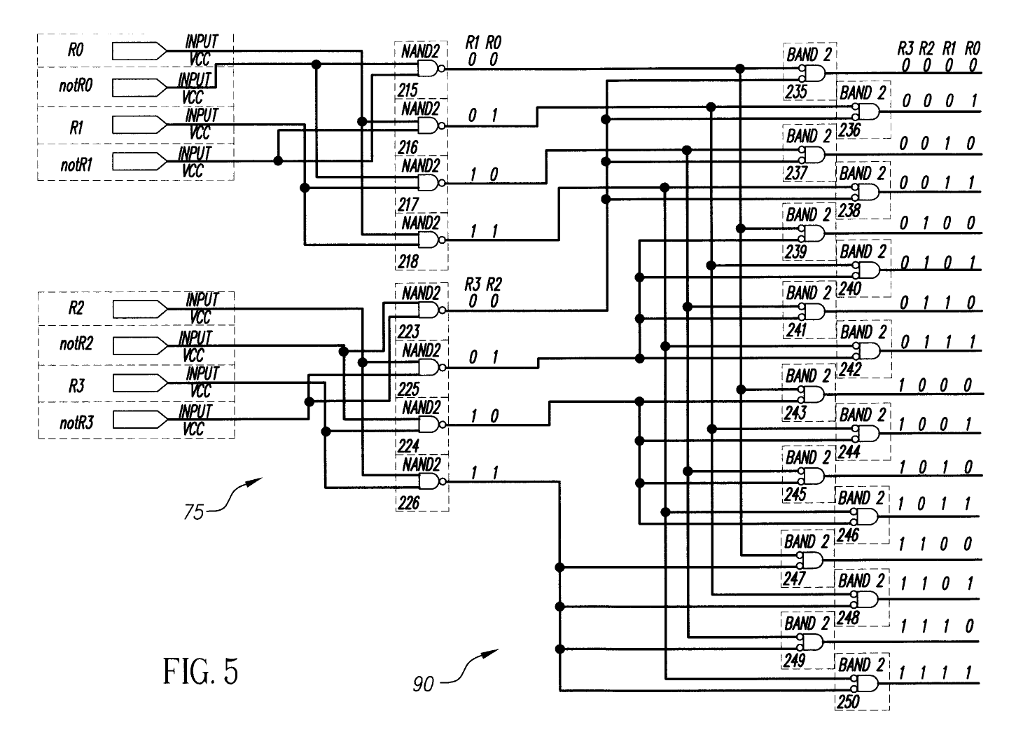

Turning now to FIG. 5, there is shown a schematic drawing of one embodiment of a random access decoder. For simplicity, a 4-to-16 decoder is shown, wherein 4 address lines of address bus 75 can activate one of up to 16 select lines 90. Such decoders are well known in the art and are commonly used in random-access memory devices. Those skilled in the art will understand that other logic combinations are possible.

Control circuitry 60 of FIG. 1 controls random access decoding circuit 40 and column select circuitry 30 so that each pixel is activated for a time corresponding to its desired brightness. Control circuitry 60 produces the addresses for random access decoding circuit 40 and provides them via address bus 75. Control circuitry 60 accesses the display data in memory buffer 50 and provides the appropriate display data signals to column select circuitry 30 via data signal bus 65. Control circuitry 60 also provides activation signals to column select circuitry 30. Control circuitry 60 is e.g. an application-specific integrated circuit (ASIC) or field-programmable gate array (FPGA), which are well known in the art.

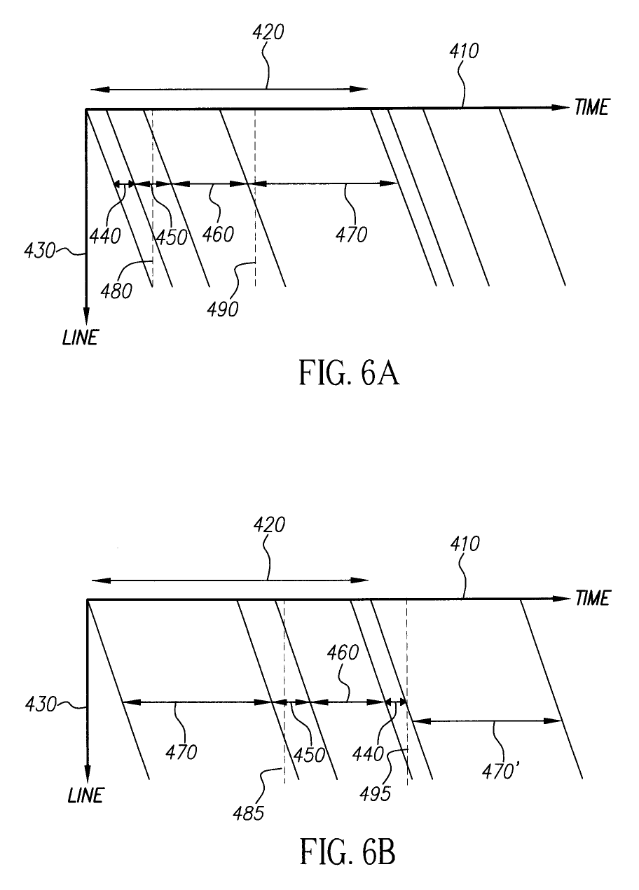

Turning now to FIG. 6A, there is shown a graphical view of an embodiment of a digital drive scanning sequence that is used in this invention. The horizontal axis shows time 410, and the vertical axis shows horizontal scanning lines 430. FIG. 6A gives an example of four-bit, sixteen gradation digital driving for ease of description.

In digital driving, one cycle or frame period 420 contains a plurality of different time windows 440, 450, 460, and 470, wherein each time window has different time values, with the time windows weighted so as to correspond to bit data representing display element brightness. That is, the time values of N time windows within a cycle have the ratio of 1:2:4:8: . . . :2^{N}. The illumination periods in this example are therefore controlled so as to give, approximately, 440:450:460:470=1:2:4:8. When an intensity bit is “1” (that is, an activating data voltage), the pixel is activated or illuminated for the corresponding time window, which is herein called an activated time window. When an intensity bit is “0” (that is, a deactivating data voltage), the pixel is deactivated or extinguished for the corresponding time window, which is herein called a deactivated time window. The total time of activated time windows for a given pixel circuit and its display element corresponds to the desired brightness of the display element of such circuit. A four-bit, 16-gradation display is thus possible by performing control in this manner. It is also possible, with additional time windows, to apply this to cases of greater brightness resolution using six bits or eight bits.

In the digital driving of the present invention, different portions of the display are in different time windows. For example, at time 480, a portion of the display is in time window T₀ (440), a portion is in time window T₁ (450), and another portion is in time window T₂ (460). At a later time 490, a portion of the display is in time window T₂ (460), because another portion is in time window T₃ (470). It will therefore be understood that during the course of a frame period 420 that each pixel circuit will display data from all time windows (that is, will be either activated or deactivated for the particular time window) and that the total time of activated time windows for a given pixel circuit corresponds to the desired brightness of the display element of the pixel circuit. It will be further understood from FIG. 6A that the exact start and end times for cycle 420 and its constituent time windows will vary with the row of pixel circuits, but that the magnitudes of the cycle and time windows will be the same for all rows of pixel circuits.

The time windows 440 to 470 are in a different order. FIG. 6B shows a graphical view of another embodiment of a digital drive scanning sequence that is used in this invention. In this embodiment, the shortest time windows have been separated to reduce the number of rows of pixels that should be updated at a given time. The order of time windows will determine the order in which rows of the display are to be written.

It is a particular feature of this invention that many changes such as these is made simply by changing the program of control circuitry 60. For example, the brightness resolution of the display is increased to six or eight bits, or even greater, simply by changing the programming, provided that the clock time of the display is sufficient.

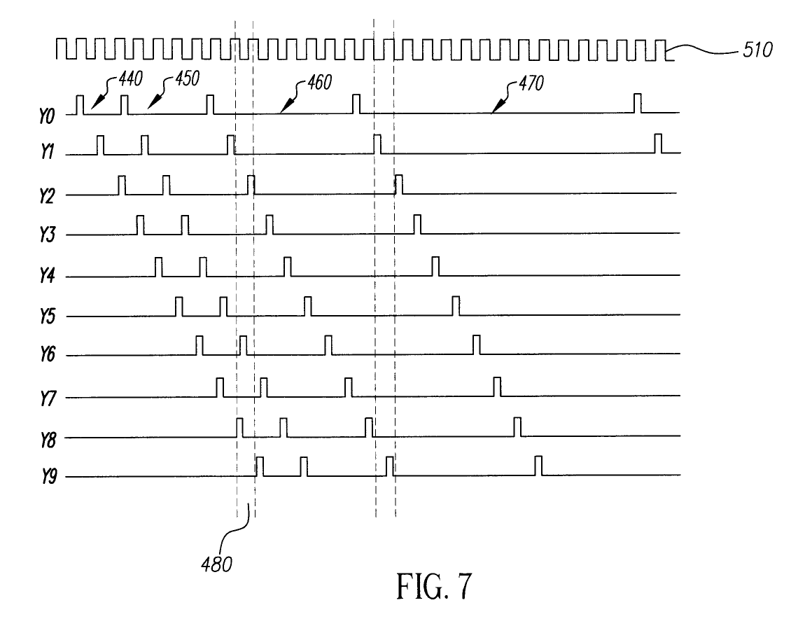

Turning now to FIG. 7, there is shown an expanded view of the timing signals of a portion of FIG. 6A. A ten-line display is considered for ease of description.

Clock 510, which is also called Tckv, represents a measurement of the pulse intervals determining the timing windows. In this embodiment, the time windows are approximately T₀=2*Tckv, T₁=4*Tckv, T₂=8*Tckv, and T₃=16*Tckv; however, this will vary slightly because different time windows will begin at different parts of a clock cycle. For example, in the clock cycle represented by time 480, line Y₈ is activated at the beginning of the cycle, line Y₆ at the middle of the cycle, and line Y₂ at the end of the cycle. Which line is active at a given time is controlled by random access decoder 310. During time 480, the row activated by line Y₈ is loaded with bit 0, the row activated by line Y₆ is loaded with bit 1, and the row activated by line Y₂ is loaded with bit 2.

Kawabe's use of a single shift register and several enable control lines forced some compromises that are not necessary in this invention. It is desired that the time values of the time windows have the ratio of 1:2:4:8 . . . etc. to achieve true digital drive. Kawabe used time windows of 1:2.5:4:8 to avoid an enable control line activating two rows simultaneously. Because a random access decoder is used instead of enable control lines and a select register, the invention described herein does not suffer this limitation, and the time values of time windows is much closer to those desired.

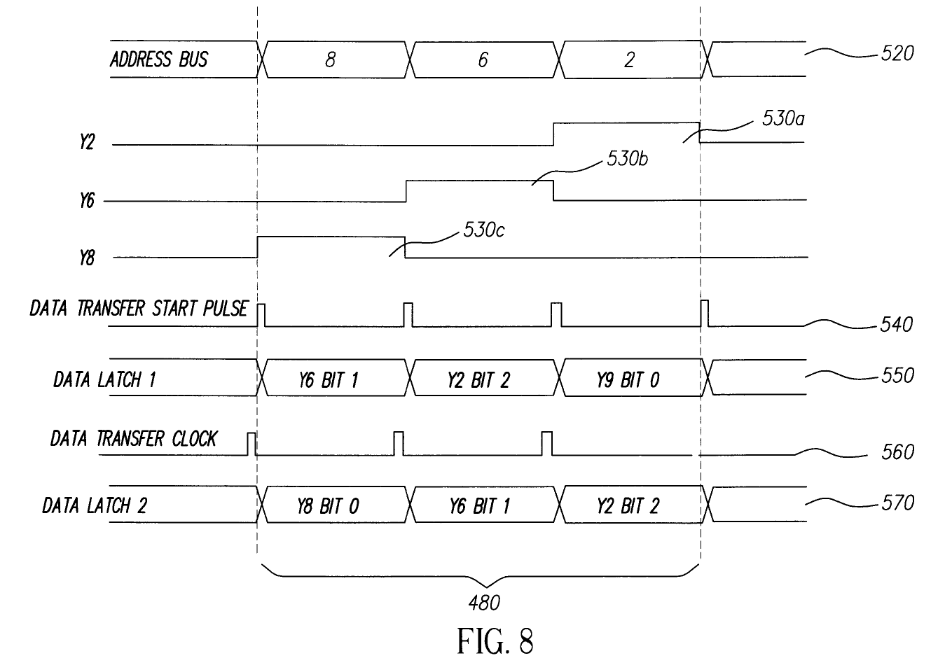

Turning now to FIG. 8, there is shown an expanded view of time 480 of FIG. 7 with additional signals. Select signals 530a, 530b, and 530c are selecting pulses for Y2, Y6, and Y8, respectively, at the end, middle, and beginning portions of time 480, respectively. Activating or deactivating signals are applied simultaneously to power transistors 160 through select transistors 150 a row at a time. The select signals allow the activation or deactivation of power transistors 160 a row at a time by activating select transistors 150 a row at a time, thus allowing the activating or deactivating data signals to be written to hold capacitors 170 and power transistors 160. Latch 2 data signal value 570 shows the data on second data latch 240, which is written to the pixels of the selected row. Latch 1 data signal value 550 shows the data on first data latch 230, which will be transferred to second data latch 240 for the next write cycle. Data transfer start pulse signal 540 is used to sequentially latch data on data signal bus 65 to first data latch 230. Data transfer clock 560 is for transferring data of first data latch 230 to second data latch 240.

In the first third of time 480, the address signal value 520 is equal to 8, and therefore only line Y8 is “High” or selected. The data of second data latch 240 is data for bit 0 of the row of pixels selected by line Y8 at this timing. This data is then written to the pixels of the selected row. In the second third of time 480, the address bus value 520 equals 6, and only line Y6 is selected. The data of second data latch 240 is data for bit 1 of the row of pixels selected by line Y6 at this timing. This data is then written to the pixels of the selected row. In the final third of time 480, address bus value 520 equals 2, and only line Y2 is selected. The data of second data latch 240 is data for bit 2 of the row of pixels selected by line Y2 at this timing. This data is then written to the pixels of the selected row.

Once the data on data line 80 is written to a pixel circuit, the power transistor 160 of such circuit is in an activated or deactivated state (depending on the data written) and remains activated or deactivated for the duration of the time window, that is, until the row receives a subsequent select signal. At the time of the subsequent select signal, data for the subsequent time window will be written to the pixel circuit and the state of power transistor 160 is the same as or different from the previous window's state, depending on the desired brightness of display element 180.

It will be understood from FIG. 6B that there is times (e.g. time 495) when a part of the display is being written with the data from one cycle, because another part of the display is being written with the data from another cycle, and thus the row data for two cycles should be available. Turning now to FIG. 9, there is shown a schematic view of another embodiment of a display device according to the present invention. Display device 15 includes memory 50A and memory 50B for storing the data from two cycles during the times when the writing of two cycles overlaps. Alternatively, a single memory buffer that is sufficient to hold the display data from two cycles can also be used.

The invention has been described in detail with particular reference to certain preferred embodiments thereof, but it will be understood that variations and modifications is effected within the spirit and scope of the invention.

### Parts List

10 display device
15 display device
20 display matrix
25 address decoding circuitry
30 column select circuitry
40 random access decoding circuit
50 memory buffer
50A memory buffer
50B memory buffer
55 memory bus
60 control circuitry
65 data signal bus
70 input signal bus
75 address bus
80 data line
90 select line
100 pixel circuit
130 reference potential line
140 power supply line
150 select transistor
160 power transistor
170 hold capacitor
180 display element
220 shift register
230 first data latch
240 second data latch
250 buffer
260 control signal line
310 random access decoder
320 level shifter
330 buffer
410 time
420 cycle or frame period
430 horizontal scan lines
440 time window T₀
450 time window T₁
460 time window T₂
470 time window T₃
480 time
485 time
490 time
495 time
510 clock
520 address signal value
530a select signal
530b select signal
530c select signal
540 data transfer start pulse signal
550 latch 1 data signal value
560 data transfer clock
570 latch 2 data signal value

What is claimed is:

1. A display device comprising:
a) a plurality of pixel circuits arranged in a matrix of rows and columns, wherein each pixel circuit includes a display element and a plurality of thin-film transistors, including a select transistor and a power transistor, for controlling the current flow through the display element, and each display element causes display light to be produced;
b) data lines corresponding to the columns of pixel circuits of the display matrix for providing activating or deactivating data signals to the pixel circuits;
c) a plurality of select lines corresponding to the rows of pixel circuits of the display matrix for providing select signals to designated select transistors in the rows of the matrix such that when an activating or deactivating data signal is simultaneously applied to the power transistor through the select transistor with a select signal to a pixel circuit the power transistor of such circuit is respectively activated or deactivated and produces a predetermined current flow through the corresponding display element, such power transistors remaining activated or deactivated at least until the row receives a subsequent select signal; and
d) address decoding structure for causing the activation or deactivation of the pixel circuits a row at a time during a cycle containing a plurality of different time windows, wherein each time window has different time values, the total time of activated windows for a given pixel circuit corresponds to the desired brightness of the display element of such circuit, such address decoding structure including:
i) column select circuitry for providing the activating and deactivating data signals on the data lines;
ii) a random access decoder responsive to address signals for providing the select signals on the select lines of a desired row in the matrix; and
iii) control circuitry for producing the addresses for the random access decoder and for providing data signals to the column select circuitry so that each pixel is activated for a time corresponding to its desired brightness.

2. The display device of claim 1 wherein the display element is an organic light-emitting diode.

3. The display device of claim 1 wherein the pixel circuits include at least three different colored pixels.

4. The display device of claim 3 wherein the different colored pixels include red-, green-, and blue-light-emitting pixels.

5. The display device of claim 4 further including white-light-emitting pixels.

6. The display device of claim 1 wherein the pixel circuits, the data lines, and the select lines are formed on a display substrate.

7. The display device of claim 6 wherein the column select circuitry is formed on the display substrate.

8. The display device of claim 6 wherein the random access decoder is formed on the display substrate.

9. The display device of claim 1 further including a memory buffer.

10. The display device of claim 9 wherein the memory buffer is sufficient to hold the display data of two cycles.

11. The display device of claim 1 wherein the time values of the time windows within a cycle have the ratio of 1:2:4:8: . . . :2^{N}.
